(19) United States
(12) Patent Application Publication
(10) Pub. No.: US 2010/0276617 A1
(43) Pub. Date: Nov. 4, 2010

(54) FLOW CHANNEL SWITCHING VALVE

(75) Inventor: Kenichi Yasunaga, Kyoto (JP)

Correspondence Address: J C PATENTS, 4 VENTURE, SUITE 250, IRVINE, CA, 92618, US

(73) Assignee: SHIMADZU CORPORATION, Kyoto (JP)

(21) Appl. No.: 12/809,225

(22) PCT Filed: Feb. 14, 2008
(86) PCT No.: PCT/JP2008/052467

§ 371 Date: Jun. 18, 2010

(51) Int. Cl. F16K 31/02

(52) U.S. Cl. 251/129.11

(57) ABSTRACT

In order to improve the durability of a rotor, a flow channel switching valve is provided, which includes a stator having a contact plane and a rotor having a contact plane. The stator has circulation openings on the contact plane, and the circulation openings are respectively connected to a plurality of flow channels. The rotor has at least one groove for communicating two of the circulation openings of the stator. The rotor is forced to press against the contact plane of the stator to rotationally slide, so as to switch the circulation openings of the stator that need to be communicated. Polishing is performed on the contact plane of the stator after being applied with a diamond like carbons coating. Furthermore, the contact plane of the rotor is made of a resin.

### BACKGROUND OF THE INVENTION

1. Field of the Invention

The present invention generally relates to a flow channel switching valve for an analysis device such as a high performance liquid chromatograph.

2. Description of Related Art

In order to select a solution such as a sample or a solvent or introduce a sample into an analysis system from the exterior, an analysis device has a flow channel switching mechanism. For example, a high performance liquid chromatograph has a mechanism for switching mobile-phase flow channels for liquid transportation under a high pressure (several ten MPa) to introduce a sample solution under the atmospheric pressure into the flow channels, and the mechanism has a flow channel switching valve.

In the prior art, the following flow channel switching valve (for example, Patent Document 1) is used for the above purpose, in which a disc-like rotor formed with switching grooves is capable of rotating while contacting a disc-like stator plane formed with through holes in communication with the grooves. In the flow channel switching valve, the stator is clamped between a top housing connected to flow channels and the rotor, and the liquid leakage of flow channels is prevented through surface contact between the rotor and the stator. Moreover, the rotor is made to rotationally slide for a constant angle from a specified position to switch the connected flow channels. Considering the materials of the flow channel switching valve in the prior art, the rotor is made of a resin such as polyetheretherketone (PEEK) or polyimide (PI), whereas the stator is made of ceramic, etc.

After long-term use of the flow channel switching valve, a sliding surface of the rotor (resin) softer than the stator (ceramic) is worn, thereby resulting in the following problems: increased torque of the valve, fluid leakage, and serious cross contamination caused by liquid remaining at the worn part of the rotor, etc.

In the flow channel switching valve, in order to prevent the liquid leakage, the rotor is pressed on the stator under a large force. If the rotor is rotated in this state, and the rotor is made of a resin, surfaces of the stator and the rotor are cut due to rotational friction, which results in chippings and further deteriorates a back-end column. On the other hand, in the case that the rotor is made of ceramic, such chippings are not produced, but the surface roughness of contact surfaces between the stator and the rotor must be reduced and the flatness must reach a high precision in consideration of the sealing performance. If such surfaces are pressed against each other under a large force, the so-called mirror adhesion phenomenon such as linking occurs and impairs the rotational movement of the rotor.

Currently, a flow channel switching valve using a fluorine-containing carbon polymer as a rotor and having a tungsten carbide/carbon (WC/C) layer coated thereon has been proposed, thereby improving the durability of the rotor (Patent Document 2). The WC/C layer has a structure that hard WC particles are scattered in soft amorphous carbon matrix, and is formed by laminating amorphous carbon and WC alternately.

During the surface treatment of a sliding surface, people pay more attention to coating of diamond like carbon (DLC). For example, Patent Document 3 has disclosed that, a sliding surface of a piston reciprocally moving within a pump is treated into a smooth surface, and then the DLC is coated thereon. Considering that the DLC is an amorphous hard film formed by allotropes of carbon, it can be inferred that, as for sliding surfaces of the rotor and the stator of the flow channel switching valve, the WC is not used in such amorphous carbon as in Patent Document 2, and a pure DLC coating film is formed on the sliding surface of the stator.

Patent Document 1: Japanese Patent Publication No. H01-307575

Patent Document 2: U.S. Pat. No. 6,453,946

Patent Document 3: Japanese Patent Publication No. 2004-60513

### SUMMARY OF THE INVENTION

FIG. 4 (a) shows an image obtained using a scanning electron microscope (SEM) after DLC coating is applied on contact planes of a stator and a rotor. It is confirmed from the SEM image (×5000) that, the surface of the DLC coating is uneven, that is because particulate block carbon of submicron order exists. If the part that should be a smooth plane has such unevenness, various malfunctions occur. If the sliding counterpart (rotor) is resin, the unevenness aggravates the abrasion of the surface. If chippings generated by the abrasion are left on the sliding surface, a gap may be produced between the contact planes of the rotor and the stator in close contact, so as to cause liquid leakage. If the chippings flow into flow channels from openings disposed on the stator surface, a column is deteriorated or the flow channels are jammed as described above. Besides, since the stator surface and the rotor surface are pressed to rotate under a large force, if the unexpected friction is produced due to the surface unevenness, the power of a motor for rotating the rotor becomes insufficient for switching the flow channels, and as a result, the flow channel switching valve fails to be operated. If the flow channel switching valve fails to be operated, an entire analysis device for forming the flow channels cannot maintain its normal operation. In most cases, upon sensing an abnormal rising of the pressure, a safety system starts to run and the analysis device is stopped.

FIG. 4 (b) shows an image of a contact plane of a stator that is shot after a switching valve is assembled by using a DLC coating film and contact planes of a rotor and the stator are made to slide for 200 times. It is confirmed from the contact plane of the stator that chippings are produced due to the abrasion of the rotor. If the switching operation for merely 200 times results in the abrasion to such an extent, the switching valve cannot be used as the flow channel switching valve for liquid chromatographs, and such flow channel switching valve is sometimes required for performing continuous analysis of up to thousands of samples.

Accordingly, the present invention is directed to a flow channel switching valve, that a DLC coating is applied on a stator surface and has a long service lifetime.

The present invention provides a flow channel switching valve, which includes a stator and a rotor provided with contact planes connected to each other. The stator includes circulation openings on the contact plane thereof, in which the circulation openings are respectively connected to a plurality of flow channels. The rotor includes at least one groove for communicating two of the circulation openings of the stator. The rotor is forced to press against the contact plane of the stator to rotationally slide, so as to switch circulation openings of the stator that need to be communicated. Moreover, the contact plane of the rotor in contact with the stator is made of a resin, and a DLC coating film after being processed by polishing is formed on the stator.

Before the DLC coating is applied, the part of the stator serving as the contact plane is processed into a smooth surface through polishing. The polishing is preferably a mirror polishing performed on the surface of the contact plane of the stator by using diamond abrasive particles. Considering the mechanical strength and corrosion resistance, a substrate of the stator is preferably made of stainless steel.

Polishing is performed on the contact plane that the DLC coating is applied by using aluminum oxide abrasive particles, so as to remove particulate block carbon of submicron order on the coating surface.

### EFFECT OF THE INVENTION

Carbon particulate blocks on the surface of the DLC coating can be removed by polishing, so as to improve the slidability on the contact planes of the rotor and the stator and prevent the torque of the rotor from being increased. The abrasion on the rotor brought by the surface of the stator is reduced, so that the flow channel switching valve can be stably used for a long time, thereby avoiding the column deterioration or piping blockage resulted from chippings produced by the rotor. Besides, by maintaining the close contact between the contact planes of the rotor and the stator, the liquid leakage is prevented, and flow channels are switched reliably without cross contamination.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view of a stator part and a rotor part of a flow channel switching valve.

FIG. 2 is an overall schematic cross-sectional view of a flow channel switching valve.

FIG. 3 shows an SEM image (a) after polishing is performed on a DLC coating of a surface of a stator and an optical image (b) after the surface of the stator is used according to the present invention.

FIG. 4 shows an SEM image (a) after DLC coating is applied on a surface of a stator in the prior art and an optical image (b) after the surface of the stator is used in the prior art.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The embodiment of the present invention is illustrated below with reference to the drawings.

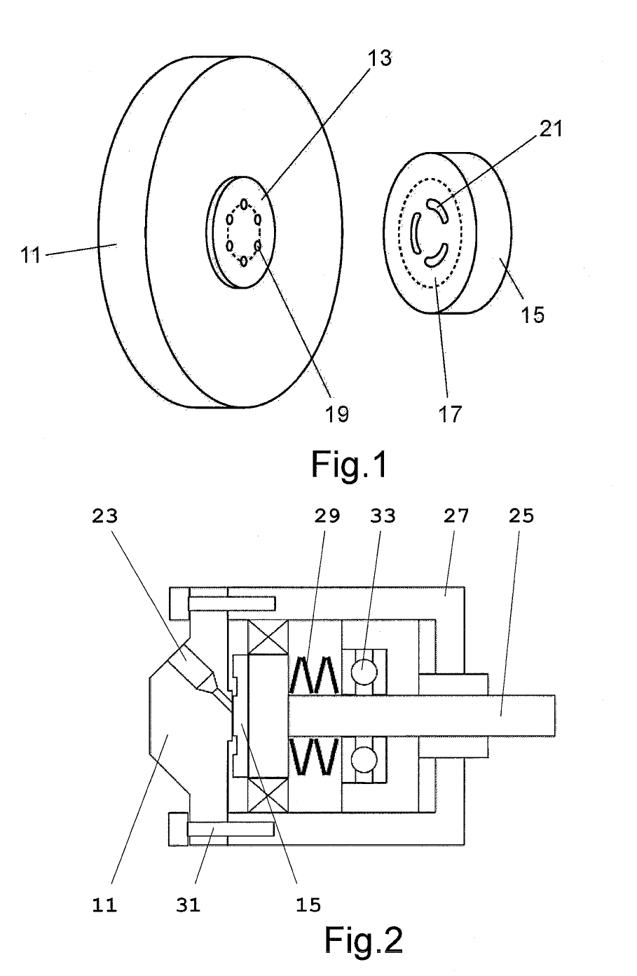

FIG. 1 is a schematic perspective view of a stator part and a rotor part of a flow channel switching valve according to an embodiment.

A stator 11 is made of stainless steel, and is integrally formed with a housing connected to flow channels. A stator sliding surface 13 of the stator 11 is connected to a rotor sliding surface 17 of a rotor 15, and through holes 19 disposed on the stator 11 are in communication with grooves 21 disposed on the rotor 15. The rotor 15 is made of, for example, a resin such as PEEK, and includes a plurality of arc-shaped grooves 21.

In order to improve the slidability, the polishing (mirror machining) is performed on the stator sliding surface 13 of the stator 11 made of stainless steel by using preferably diamond abrasive particles (particle diameter of 1-3 μm).

A DLC coating having a thickness of about 2 μm is formed on the mirror machined sliding surface 13 of the stator 11 made of stainless steel by a magnetron sputtering method. If the DLC coating is formed by the magnetron sputtering method, liquid drops are not easily attached to the coating surface, so as to obtain a smooth surface, thereby reducing the friction coefficient and the abrasion of the rotor. The coating of the DLC is a technically stable forming method having desirable sealing performance with the mirror machined stator sliding surface. After the coating of the DLC, the polishing is performed. The polishing different from that performed on the substrate of the stator made of stainless steel may also be employed. Under more flexible polishing conditions, the polishing is performed by using aluminum oxide abrasive particles (particle diameter of 1-3 μm) to eliminate only carbon particulate blocks.

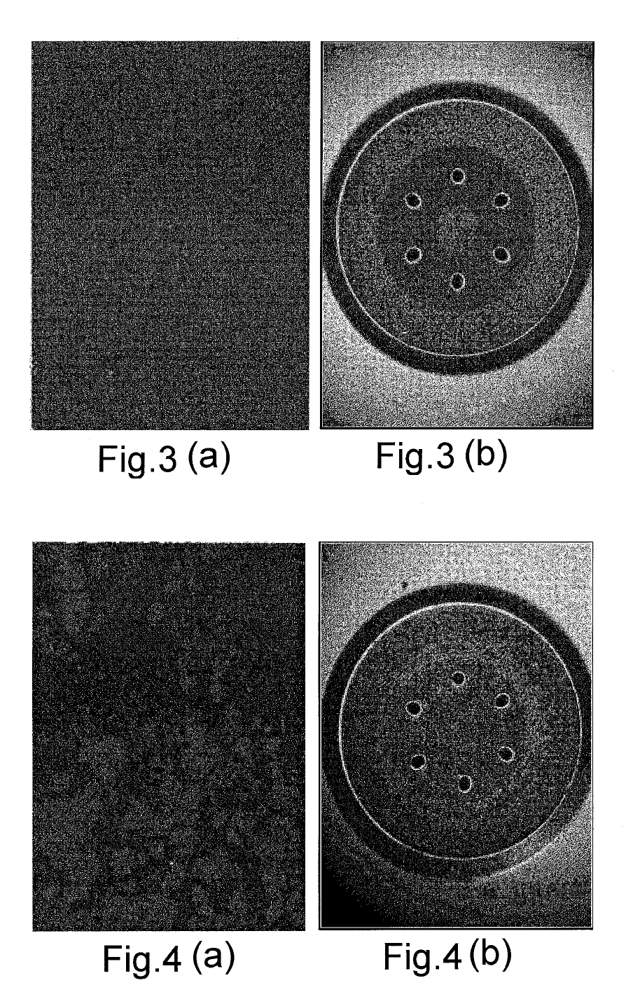

FIG. 3 (a) shows an SEM image after DLC is coated on contact planes of a stator and a rotor and then polishing is performed on a flow channel switching valve according to the present invention. From the SEM image (×5000), no unevenness shown in FIG. 4 (a) is confirmed on the surface of the DLC coating. It can be known that, a smooth plane is formed by performing polishing using aluminum oxide abrasive particles after the coating of the DLC. FIG. 3 (b) shows an image of a contact plane of a stator that is shot after the switching valve is assembled by performing polishing after the coating of the DLC and the contact planes of the rotor and the stator are made to slide for 200 times. Under the same conditions as in FIG. 4 (b), no chippings resulted from the abrasion of the rotor are confirmed on the contact plane of the stator. The aluminum oxide abrasive particles are used for polishing after the coating of the DLC. Thus, even if the sliding counterpart (rotor) is resin, the abrasion of the resin is confirmed to be reduced.

FIG. 2 is a schematic cross-sectional view illustrating an overall construction of a flow channel switching valve. The stator 11 is provided with a plurality of flow channel connecting portions 23, and front ends of the flow channel connecting portions 23 are in communication with the through holes 19 of the contact plane 13. The rotor 15 is installed in a front end of a shaft 25, and is forced towards the stator 11 through an elastic member 29 disposed in a body portion 27 that supports the shaft 25 to rotate. The body portion 27 is screwed on the external periphery of the stator 11 by a screw 31. The grooves 21 are formed on the contact plane 17 of the rotor 15 (shown in FIG. 1), and are in communication with the through holes 19 on the contact plane 13 of the stator 11. When flow channels are switched, the shaft 25 is rotated to drive the rotor 15 to rotationally slide relative to the stator 11, so as to switch the connection between the through holes 19 and the grooves 21. In this example, the part (the housing) provided with the flow channel connecting portions 23 is integrally formed with the stator 11. The housing and the stator may be integrally formed to shorten flow channels inside the flow channel switching valve and reduce the volume in the flow channels, so as to inhibit diffusion of the ingredients of the sample. Alternatively, the housing and the stator may also be separately formed as in an ordinary flow channel switching valve.

When the flow channel switching valve in the present invention is used in a liquid chromatograph, the flow channel connecting portion 23 is connected to a liquid transportation device for transporting mobile phases, a sample loop for measuring sample solutions, or a column for separating sample solutions according to each ingredient, etc.

In this embodiment, the through holes 19 on the contact plane of the stator are arranged on a circumference, and the groove 21 of the rotor is in communication with two of the through holes, which may be similarly applied in a flow channel switching valve generally referred to as a “multi position valve”. In the multi position valve, a common through hole is arranged in the center of a contact surface of a stator, and a plurality of through holes is arranged on the circumference of the common through hole, and grooves of a rotor extend along a radial direction, so that the common through hole of the stator is selectively connected to any through hole on the circumference.

### INDUSTRIAL APPLICABILITY

The present invention can be applied in an analytical instrument that requires flow channel switching, mainly high performance liquid chromatographs, or other instruments.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A flow channel switching valve, comprising: a stator and a rotor provided with contact planes connected to each other, wherein the stator comprises circulation openings on the contact plane thereof, and the circulation openings are respectively in communication with a housing connected to a plurality of flow channels, the rotor comprises at least one groove for communicating two of the circulation openings of the stator on the contact plane, the rotor is forced to press against the contact plane of the stator to rotationally slide, so as to switch circulation openings of the stator to be communicated, and the contact plane of the stator is formed by polishing a substrate of the stator, forming a coating film by using diamond like carbon (DLC), and then performing polishing on the coating film.

2. The flow channel switching valve according to claim 1, wherein the substrate of the stator is made of stainless steel.

3. The flow channel switching valve according to claim 2, wherein the substrate of the stator is abraded by using diamond abrasive particles.

4. The flow channel switching valve according to claim 2, wherein aluminum oxide abrasive particles are used for polishing the coating film.

5. The flow channel switching valve according to claim 1, wherein the stator is integrally formed with a housing connected to flow channels.

6. The flow channel switching valve according to claim 3, wherein aluminum oxide abrasive particles are used for polishing the coating film.
